(19) United States
(12) Patent Application Publication
(10) Pub. No.: US 2016/0345755 A1
(43) Pub. Date: Dec. 1, 2016

(54) PRIVACY ENHANCEMENT SYSTEM

(71) Applicant: Doreen Clark, Harrisburg, PA (US)

(72) Inventor: Doreen Clark, Harrisburg, PA (US)

(21) Appl. No.: 15/137,358

(22) Filed: Apr. 25, 2016

Related U.S. Application Data
(60) Provisional application No. 62/180,000, filed on May 26, 2015.

(51) Int. Cl. A47G 5/00; E06B 9/24; E04H 1/12

(52) U.S. Cl. CPC A47G 5/00; E04H 1/1266; E06B 9/24

(57) ABSTRACT

A privacy enhancement system is provided for use by an occupant in an enclosure including a collapsible material layer having a masking surface for covering a gap in the enclosure. The enclosure substantially laterally surrounds an occupant for providing privacy for the occupant, the gap extending along at least a laterally surrounding portion of the enclosure remaining after an occupant entrance to the enclosure is closed with the occupant positioned interior of the enclosure. The material layer has a securing feature for selectably securing the material layer to the enclosure over the gap, the material layer forming a visual barrier along the gap.

### BACKGROUND

The application relates generally to privacy enhancement systems and, more particularly, to portable privacy enhancement systems.

Public restrooms configured to accommodate multiple persons at once often contain enclosures or stalls for purposes of privacy. A freestanding restroom stall of conventional construction typically includes a door positioned between a pair of opposed walls. Typically, the door is pivotably connected to one of the walls and is secured to the other wall such as by a latch when the door is in a closed position with an occupant inside of the stall. Unfortunately, there typically exists a gap on both sides of the door extending between the corresponding walls of the stall, resulting in diminished privacy for the occupant as a result of being viewable by others positioned outside of the stall.

Accordingly, there is an unmet need for a privacy enhancement system that does not suffer from such shortcomings.

### SUMMARY

One embodiment of the present invention is directed to a privacy enhancement system for use by an occupant in an enclosure, including a collapsible material layer having a masking surface for covering a gap in the enclosure. The system further includes the enclosure substantially laterally surrounding an occupant for providing privacy for the occupant. The system further includes the gap extending along at least a laterally surrounding portion of the enclosure remaining after an occupant entrance to the enclosure is closed with the occupant positioned interior of the enclosure. The system further includes the material layer having a securing feature for selectably securing the material layer to the enclosure over the gap, the material layer forming a visual barrier along the gap.

Another embodiment of the present invention is directed to a privacy enhancement system for use by an occupant in a restroom stall, including a collapsible material layer having a masking surface for covering at least one gap in the restroom stall. The system further includes the restroom stall substantially laterally surrounding an occupant for providing privacy for the occupant. The system further includes the at least one gap extending along at least a laterally surrounding portion of the restroom stall remaining after an occupant entrance to the restroom stall is closed with the occupant positioned interior of the enclosure. The system further includes the material layer having a securing feature for selectably securing the material layer to the restroom stall over the at least one gap, the material layer forming a visual barrier along the at least one gap.

Another embodiment of the present invention is directed to a method for providing privacy for an occupant in an enclosure, including providing a collapsible material layer having a masking surface for covering a gap in the enclosure, the enclosure substantially laterally surrounding an occupant for providing privacy for the occupant, the gap extending along at least a laterally surrounding portion of the enclosure remaining after an occupant entrance to the enclosure is closed with the occupant positioned interior of the enclosure. The method further includes closing the enclosure with the occupant interior of the enclosure. The method further includes selectably securing the material layer to the enclosure over the gap, the material layer forming a visual barrier along the gap.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE FIGURES

FIG. 1 shows a perspective view of an exemplary privacy enhancement system secured to an enclosure.

FIG. 2 shows an exemplary privacy enhancement system.

FIG. 3 shows an exemplary privacy enhancement system.

FIG. 4 shows an exemplary privacy enhancement system.

FIGS. 5 and 6 show an exemplary privacy enhancement system in a collapsed position.

FIG. 7 shows an exemplary privacy enhancement system in an extended position.

FIG. 8 shows the privacy enhancement system of FIG. 7 in a collapsed position.

### DETAILED DESCRIPTION OF EXEMPLARY EMBODIMENTS

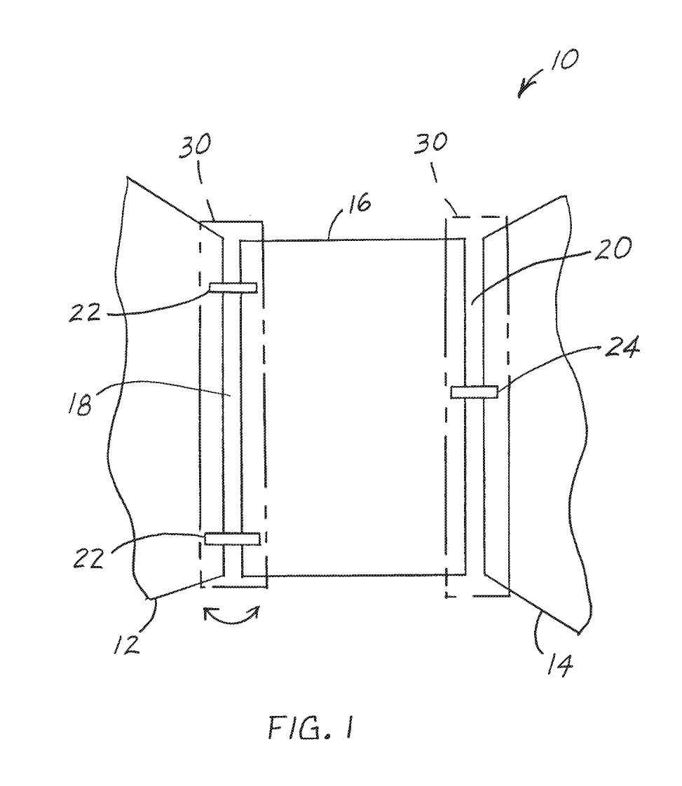

FIG. 1 shows an exemplary privacy enhancement system 30 secured to an enclosure 10 for providing enhanced privacy for an occupant positioned interior of enclosure 10 from viewing by others positioned exterior of the enclosure. Enclosure 10 may be a restroom stall, a changing area, a shower, a curtain and combination thereof. As further shown in FIG. 1, enclosure 10 includes an opposed pair of walls 12, 14 separated by a door 16. Walls 12, 14 and door 16 substantially laterally surround an occupant (not shown) positioned interior of the enclosure. That is, walls 12, 14 and door 16 are of sufficient length and positioned to laterally surround an occupant, such that an occupant positioned interior of enclosure 10 is not generally viewable from above or below the walls and door of the enclosure by another positioned exterior of the enclosure.

One side of door 16 is pivotably secured to wall 12 by hinges 22. To permit pivotable movement of door 16 relative to wall 12, hinges 22 maintain a gap 18 between wall 12 and door 16. The opposite side of door 16 is selectably latched to wall 14 by a latch 24. A gap 20 is maintained between door 16 and wall 14 to permit movement of door 16 relative to wall 14. Gaps 18, 20 extend along at least the laterally extending portion of the enclosure. Gaps 18, 20 result in diminished privacy for the occupant as a result of the occupant being viewable through the gaps by others positioned outside or exterior of enclosure 10. A privacy enhancement system 30 can be selectably secured over or covering gaps 18, 20, forming a visual barrier along the gaps.

It is to be understood that the term “enclosure” encompasses different structural arrangements, including freestanding arrangements, e.g., three or more walls, and that walls of the enclosure include any combination of walls, such as for a freestanding arrangement and walls supporting a larger structure, e.g., walls of a restroom. That is, one or more walls of a restroom can serve as one or more walls of the enclosure. In one embodiment, an enclosure may include a door that is slidably movable relative to the remaining structure of the enclosure, there existing a gap between the door and the rest of the enclosure that is covered by the privacy enhancement system of the present application. In one embodiment, an enclosure may include a flexible member, such as a curtain, that maintains a gap between the flexible member and the rest of the structure of the enclosure which provides reduced privacy for an occupant positioned interior of the enclosure. In summary, irrespective of the structural arrangement of the enclosure, the privacy enhancement system of the present application may be used to cover one or more gaps remaining in the enclosure to prevent viewing of an occupant positioned interior of the enclosure, such as by another positioned exterior of the enclosure.

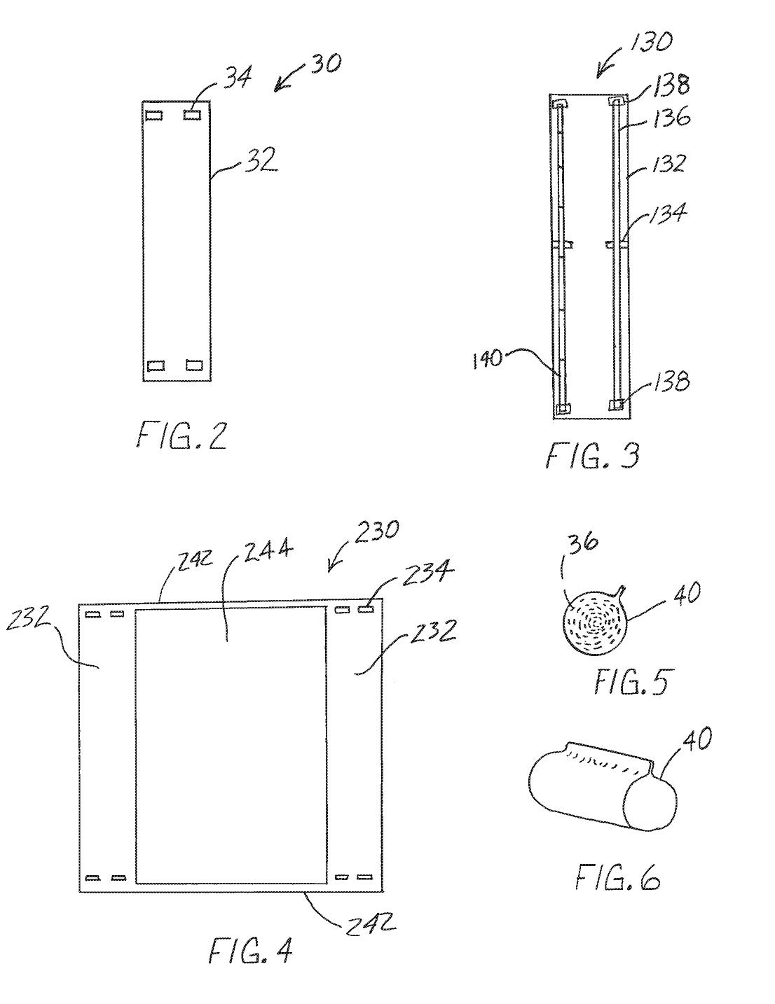

As shown in FIG. 2, privacy enhancement system 30 includes an elongated material layer 32, also referred to as a strip, and one or more securing features 34. Securing features 34 can include, but are not limited to, latches, hooks, clips, magnets, suction cups, adhesive surfaces or other suitable devices or features for securing material layer to an enclosure over a gap formed in the enclosure, such as shown in FIG. 1. One or more securing features 34 can be removably secured to material layer 32. In one embodiment, one or more securing features 34 can be permanently secured to material layer 32. In one embodiment, one or more securing features 34 can be at least partially embedded within a material layer 32, such as by molding, a portion of the material layer being folded over the securing feature or other process or technique. In one embodiment, securing features 34 can be selectively secured to and removed from an enclosure without tools. That is, an occupant positioned interior of an enclosure should be able to easily manually secure or remove the privacy enhancement system of the present disclosure from the enclosure. In one embodiment, the securing features are not accessible by an observer positioned exterior of the enclosure.

As further shown FIG. 2, material layer 32 can be continuous. That is, the material layer is substantially devoid of openings permitting unobstructed viewing therethrough, such as when the material layer is secured to an enclosure covering a gap. The material layer includes a masking surface. The term “masking surface” is intended to mean a surface that is opaque or at least sufficiently translucent so as to prevent viewing therethrough.

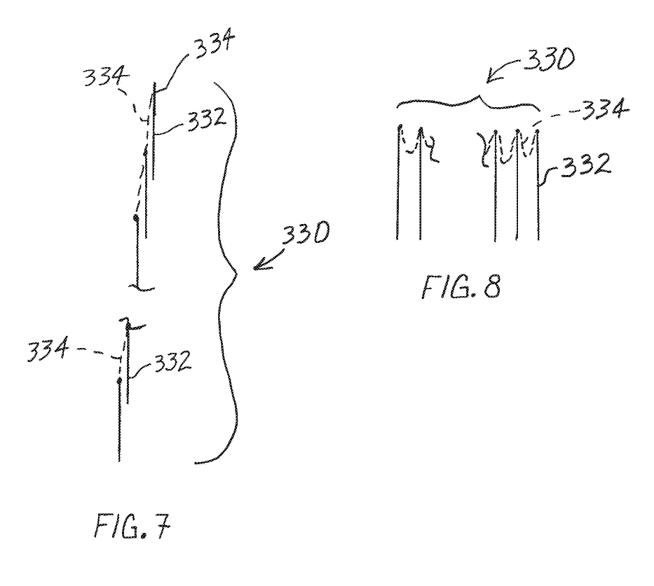

As shown in FIGS. 5 and 7-8, the material layer of the privacy enhancement system of the present application is collapsible. That is, the material layer can be reduced in size, for convenient, compact portability, such as being capable of fitting in a purse, such as a woman's purse, by rolling up (e.g., similar to a carpet), folding, disassembly or a combination thereof. As further shown in FIGS. 5 and 6, a collapsed material layer 36 has been rolled up and inserted inside of a container 40 for purposes of convenient, compact portability and hygiene. FIG. 7 shows, in an exemplary embodiment, a privacy enhancement system 330 having a plurality of material layers 332 are interconnected by flexible material 334 and operating in a similar manner to a venetian blind, with FIG. 7 showing privacy enhancement system 330 in an extended position, and FIG. 8 showing privacy enhancement system 330 in a collapsed position.

FIG. 3 shows an exemplary embodiment of the privacy enhancement system. Privacy enhancement system 130 includes a material layer 132 and securing features 134 operating in a similar manner to that previously disclosed. A pair of collapsible members 136 are secured to material layer 132 by corresponding engagement features 138. Collapsible members 136 can include, but are not limited to telescoping members (e.g., portable radio antennas) interconnected segments 140 using ball lock ends or threaded ends or other suitable arrangements. Privacy enhancement system 130 provides a rigid, self-supporting construction, permitting securing features 134 to be positioned away from an upper end of material layer 132, versus non-supporting systems only having a flexible material layer and securing features from which the flexible material layer dangles. It is to be understood that the arrangement and number of securing features, engagement features and collapsible members and/or combination thereof can be different in other embodiments.

FIG. 4 shows an exemplary embodiment of the privacy enhancement system. Privacy enhancement system 230 includes a material layer 232 and securing features 234 operating in a similar manner to that previously disclosed. However, a pair of material layers 232 are connected by a pair of corresponding connecting strips 242. Optionally, an opening 244 is formed in material layer 232. In the present embodiment, a single material layer can be constructed to cover multiple gaps, while permitting a more compact construction when the material layer is collapsed, as compared to a continuous material layer. It is to be understood that the arrangement and number of securing features, engagement features and collapsible material and combination thereof can be different in other embodiments.

Preferably, the material layer and container of the privacy enhancement system of the present application is capable of being cleansed or disinfected, permitting repeated use, while maintaining hygiene. In one embodiment, the material layer is a polymer. In one embodiment, the material layer is a plastic. In one embodiment the material layer is a fabric, or other suitable material.

It is to be understood that the arrangement and number of securing features, engagement features, openings and collapsible members and/or combination thereof can be different in other exemplary embodiments.

While only certain features and embodiments of the invention have been shown and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation-specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. A privacy enhancement system for use by an occupant in an enclosure, comprising:
a collapsible material layer having a masking surface for covering a gap in the enclosure, the enclosure substantially laterally surrounding an occupant for providing privacy for the occupant, the gap extending along at least a laterally surrounding portion of the enclosure remaining after an occupant entrance to the enclosure is closed with the occupant positioned interior of the enclosure; and
the material layer having a securing feature for selectably securing the material layer to the enclosure over the gap, the material layer forming a visual barrier along the gap.

2. The privacy enhancement system of claim 1, wherein the enclosure is selected from the group consisting of a restroom stall, a changing area, a shower, a curtain and combination thereof.

3. The privacy enhancement system of claim 1, wherein the material layer is continuous.

4. The privacy enhancement system of claim 1, wherein the securing feature is selectively securable to and removable from the enclosure without tools by the occupant positioned interior of the enclosure.

5. The privacy enhancement system of claim 1, wherein the material layer is a capable of being cleansed.

6. The privacy enhancement system of claim 1, further comprising a container for storing the material layer in a collapsed position.

7. The privacy enhancement system of claim 1, wherein the material layer is a polymer.

8. The privacy enhancement system of claim 1, wherein the material layer is a plastic.

9. The privacy enhancement system of claim 1, wherein the material layer is a fabric.

10. A privacy enhancement system for use by an occupant in a restroom stall, comprising:
a collapsible material layer having a masking surface for covering at least one gap in the restroom stall, the restroom stall substantially laterally surrounding an occupant for providing privacy for the occupant, the at least one gap extending along at least a laterally surrounding portion of the restroom stall remaining after an occupant entrance to the restroom stall is closed with the occupant positioned interior of the enclosure; and
the material layer having a securing feature for selectably securing the material layer to the restroom stall over the at least one gap, the material layer forming a visual barrier along the at least one gap.

11. The privacy enhancement system of claim 10, wherein the material layer is continuous.

12. The privacy enhancement system of claim 10, wherein the securing feature is selectively securable to and removable from the enclosure without tools by the occupant positioned interior of the enclosure.

13. The privacy enhancement system of claim 10, wherein the material layer is a capable of being cleansed.

14. The privacy enhancement system of claim 10, wherein the at least one gap is formed between a door and other structure of the restroom stall.

15. The privacy enhancement system of claim 10, further comprising a container for storing the material layer in a collapsed position.

16. The privacy enhancement system of claim 10, wherein the material layer is a polymer.

17. The privacy enhancement system of claim 10, wherein the material layer is a plastic.

18. The privacy enhancement system of claim 10, wherein the material layer is a fabric.

19. A method for providing privacy for an occupant in an enclosure, comprising:
providing a collapsible material layer having a masking surface for covering a gap in the enclosure, the enclosure substantially laterally surrounding an occupant for providing privacy for the occupant, the gap extending along at least a laterally surrounding portion of the enclosure remaining after an occupant entrance to the enclosure is closed with the occupant positioned interior of the enclosure;
closing the enclosure with the occupant interior of the enclosure; and
selectably securing the material layer to the enclosure over the gap, the material layer forming a visual barrier along the gap.

20. The method of claim 19, further comprising selectably removing the material layer from the enclosure.
